(19) United States
(12) Patent Application Publication
(10) Pub. No.: US 2009/0198526 A1
(43) Pub. Date: Aug. 6, 2009

(54) PAYMENT OF BENEFITS FOR SURVIVORS OF CERTAIN MEDICAL CONDITIONS

(75) Inventors: Rita S. Golden, Columbus, GA (US); Deborah Grantham, Woodland, GA (US); Wendy Herndon, Columbus, GA (US); JoAnn King, Columbus, GA (US); Tom Morey, Columbus, GA (US); Carolyn Nelson-Tigner, Columbus, GA (US); Jason M. Van Pelt, Columbus, GA (US); Samuel L. Warren, Columbus, GA (US)

Correspondence Address: BRYAN CAVE POWELL GOLDSTEIN, ONE ATLANTIC CENTER FOURTEENTH FLOOR, 1201 WEST PEACHTREE STREET NW, ATLANTA, GA, 30309-3488, US

(73) Assignee: American Family Life Assurance Company of Columbus, Columbus, GA (US)

(21) Appl. No.: 12/364,021

(22) Filed: Feb. 2, 2009

Related U.S. Application Data
(60) Provisional application No. 61/025,188, filed on Jan. 31, 2008.

(51) Int. Cl. G06Q 40/00; G06F 19/00; G06F 3/02

(52) U.S. Cl. 705/4; 700/91; 700/82

(57) ABSTRACT

A method for payment of a benefit to a survivor of a subsequent medical condition. Initial and subsequent information about a person is received, the information concerning at least one specified medical condition. The initial information is inspected to determine the state of health of the person, the state of health not being acceptable if the specified medical condition is present. If the state of health of the person is acceptable then the person is approved for payment of a specified benefit if the specified medical condition is later present. Subsequent information about the person is inspected to determine the state of health of the person, the state of health being changed if the predetermined medical condition is later present. The specified benefit is then paid if the state of health of the person has changed.

### PRIORITY CLAIM

This application claims priority to U.S. Provisional Patent Application Ser. No. 61/025,188, entitled “Maximum Difference—Annual Benefits For Survivors And Customer Loyalty Discounts”, filed Jan. 31, 2008. The entirety of the above provisional application, including each and every attachment thereto, is hereby incorporated herein by reference.

### TECHNICAL FIELD

Payment of benefits and, more specifically, payment of benefits to persons who are alive at specified dates after diagnosis of certain medical conditions.

### BACKGROUND

Most traditional insurance policies fall into one of two areas: (1) loss or expense insurance for payment or reimbursement of submitted and approved losses or expenses, such as medical insurance which pays or reimburses for submitted and approved doctor, hospital, and medication expenses, or property insurance which pays or reimburses for submitted and approved automobile, house, or personal property damage and repair or loss, and disability insurance which reimburses for loss of income; or (2) life insurance, which provides for payment of a specified amount when an insured person dies.

Under a standard insurance policy of the first type, a customer pays the insurance provider a premium in return for coverage in case the specified losses or expenses occur. In the health insurance context, the insurance company is normally agreeing, among other things, to pay some portion of the covered expenses that a person would otherwise incur in dealing with a medical condition. A problem with these traditional policies is that they cover only specified expenses or losses, and provide no coverage for other costs which may be incurred. Such other costs may be, for example, travel expenses, lodging and meal expenses for the person who must travel outside of his/her local area for treatment, and/or for the spouse or other caretaker of that person, expenses for the care of minor children when both parents or the only parent must be away for medical care or treatment, etc. As mentioned previously, under these traditional policies, benefits are only paid to reimburse covered medical expenses, and an insured person normally must seek an approved treatment in order to receive any such benefits. As a result, persons who choose to forego treatment, or to pursue a non-conventional (i.e., non-approved) treatment, are provided few benefits, if any, during the time when such benefits might be needed the most. Even those who seek treatment, even an approved treatment, may not be fully compensated for their expenses and trouble, or even partially compensated for non-covered medical expenses or non-medical expenses.

A problem with traditional policies of the second kind is that they do not provide any benefit payment or assistance to the person while the person is still alive.

Even if a provider of insurance services is willing to consider more types of treatments or benefits under a policy of the first type, the provider is faced with a daunting task. For instance, it is necessary to obtain data on, and/or estimate, actual or typical non-medical expenses and typical non-covered medical expenses in order to make a reasonable determination as to what coverage should be offered and what the premium should be. The insurer must then determine when reimbursements will be made, under what conditions, what portion is reimbursable, and what deductible applies, per expense, per condition, etc. This is a difficult and time-consuming process and can divert resources away from other business functions and needs, such as distributing benefits to customers, updating information on approved treatments under existing types of policies, paying benefits in a timely manner, etc. This difficulty is further compounded by the rapid rate in which treatments, whether new, alternative, approved, experimental, non-approved, or even non-verified, become available, and the different locations where treatment can be provided, such as whether the treatment is available in the city or county of the person's residence, or whether treatment is only available at a remote location, such as in a different state or even in a different country. Also, whenever treatment is not available locally, other associated costs, such as travel, lodging, food, etc., may need to be considered.

### SUMMARY

If a person does not have, and preferably has not had, a specified medical condition, then a policy may be issued. Under the policy, benefits are paid to the person if the specified medical condition later occurs, but the person is still alive on a specified date. Preferably, but not necessarily, expenses associated with the specified medical condition need neither be submitted nor approved; payment is made upon proof of the existence of the specified medical condition and the person surviving on a specified date. Preferably, eligibility for such a policy is based upon the person not having a specified medical condition at the time of application for the policy, and not having had the specified medical condition at all or within a specified time.

Data about a person is received, wherein the data concerns at least one specified medical condition. The data is thus indicative of the state of health of the person. More particularly, the state of health is determined by whether the specified medical condition is now present or has been present. If the specified medical condition is now present or has been present then this indicates that the state of health of the person is not acceptable.

If, however, the state of health of the person is acceptable then the person is approved for payment of a specified benefit upon the later occurrence of the specified condition. Later, updated information about the person is received and it is then inspected to determine the new (current) state of health of the person. If the specified medical condition is later present, then the state of health has changed (deteriorated) and the specified benefit may then be paid. Preferably, but not necessarily, the benefit is paid only if the person is surviving on a specified date. Preferably, but not necessarily, this benefit is paid at specified intervals or anniversary dates.

A method for issuing such a policy and paying benefits thereunder is disclosed. An article of manufacture which provides for issuing such a policy and paying benefits thereunder is also disclosed. A machine accessible medium which contains data that, when accessed by a machine, causes the machine to perform the plurality of functions necessary for issuing and paying, is also disclosed. A computer system, particularly adapted to provide for issuing such a policy and paying benefits thereunder is also disclosed.

### BRIEF DESCRIPTION OF THE DRAWINGS

FIG. 1 is a flow chart of an exemplary embodiment.

FIG. 2 is a block diagram of an exemplary computer system for use with the present invention.

### DETAILED DESCRIPTION

The health insurance field has many costs for which policies neither account nor compensate. In one embodiment the present invention provides an insurance policy which provides some compensation for such costs. In another embodiment, the present invention provides a rider to an underlying cancer insurance policy and the rider provides some compensation for such costs. For convenience of discussion below, both the rider to an underlying cancer insurance policy, and a standalone insurance policy, are referred to as an insurance policy or just as a policy. A policy in accordance with the present invention thus provides at least some compensation for costs that may or may not be partially or fully covered by another policy. For example, in addition to the costs of actually administering immunotherapy treatment, there are many associated, necessary, and/or incidental costs arising therefrom, such as, for example, anti-nausea medication, travel, lodging, meals, transportation, and child care. Also, although information may be gathered and processed to determine the nature of hidden costs which become active upon a diagnosis that the insured has a particular medical condition such as cancer, these costs may also be less tangible and harder to define and evaluate and may vary from person to person, and from location to location, even for persons with similar or identical medical conditions. Therefore, with respect to these costs arising from the medical condition or treatment therefor, a preset dollar amount offers an effective and feasible method of compensation.

A care benefit, which is preferably, but not necessarily, an annual care benefit, at least partially offsets such costs. The care benefit covers at least some of the additional medical expenses that a person diagnosed with a condition, such as internal cancer, will incur even if the person is no longer receiving active treatments. Once a diagnosis of internal cancer is made then this person will require additional doctor visits and tests to monitor whether the condition has returned, even if the condition is removed or in remission.

The care benefit is preferably, but not necessarily, distributed regardless of the insured's decision to seek treatment. An amount set under predetermined criteria can be paid when a person is diagnosed as having a predetermined medical condition, such as cancer or a cancerous condition, while the policy is in force. Such an amount, and the timing of the payment or payments, can be set by a schedule in the initial policy, by a formula, or by a combination of the two. Such amount or amounts can be paid even if the insured is pursuing an alternative treatment or no treatment at all.

In another embodiment of the invention, the benefit is increased by a predetermined amount, such as $500 per year, on each anniversary date when the person still does not have the specified medical condition. For example, the policy could initially provide for payment of $500 or $1000 if the person is subsequently diagnosed with the specified medical condition. Then, if the person still does not have the specified medical condition at the end of the first year of the policy, then the policy payments will increase to, for example, $1500. In subsequent years, as long as the person still does not have the specified medical condition, the policy payments can continue to increase, for example, to $2000, $2500, $3000, etc. Preferably, but not necessarily, the policy payments reach a maximum benefit level after a predetermined number of years, for example, five years. If, however, the person is later diagnosed with the specified medical condition, then the payment amount becomes fixed and does not change from the last benefit level, for example, $2000.

Although the benefit is preferably payable annually if the specified medical condition becomes present, or increases annually if the specified medical condition has not become present, the annual interval is merely a preference for convenience of administration, and other intervals can be used, such as monthly, bimonthly, quarterly, semi-annually, bi-annually, etc.

Also, although the benefit payable interval and the payment increase interval are preferably the same interval, and are preferably annually, they may be different intervals if desired.

According to still another embodiment, further increases might be reduced or eliminated for a customer on the anniversary date following a predetermined date, such as the customer's 65th birthday, or on the fifth anniversary of the policy, or at the time the covered medical condition is diagnosed as being eliminated or in remission. Preferably, but not necessarily, and regardless of the customer's age, the benefit would increase for some minimum predetermined period, for example, five years, even if the person has the specified medical condition on the predetermined date.

Also, preferably, but not necessarily, a benefit is paid for a single or first occurrence of a specified medical condition after the policy issues, such that subsequent diagnoses of the same medical condition or category of conditions, such as all internal cancers, or possibly even a condition from a different category, such as cancer of a different type, would not trigger a new or additional set of periodic payments.

In one embodiment, once the policy has issued, receipt of a policy claim on a person's behalf triggers the payment review process. For instance, after the policy has been issued, the insured could subsequently be diagnosed with pancreatic cancer. The policy claim would be accompanied by a medical categorization, such as a diagnosis code. This diagnosis code would likely be provided by a physician, but it could be supplied by the claims specialist or an auditor who subsequently reviews the records. Documents can be scanned into a computer system as image files, and certain information from them can be available as text for subsequent review, analysis, and modification. Optical character recognition (OCR) techniques may be used, if desired, to extract text and data from scanned documents. The computer system may have modules that adapt the computer to, for example, check the insured's status at specified dates, such as annually over the next five years. Preferably, the information necessary to trigger the payment review process is information indicating that the specified medical condition, or another covered medical condition, is now present. Preferably, but not necessarily, submission of actual expense receipts is not required.

Upon receipt of a policy claim, a claims specialist may input diagnosis and claim information, including a diagnosis event code, and may check to ensure that the information is complete and has been properly entered. This diagnosis code is preferably used to distinguish between the kinds of cancer. Pancreatic cancer is an example of an internal cancer. An associated cancerous condition would be related to the cancer but is not the cancer itself, such as a myelodysplastic blood disorder. In one embodiment, if the claims specialist approves the claim, then the computer system immediately sets a series of dates in the future for the insured to be eligible for the care benefit if the insured is still alive. The computer system may have modules that adapt the computer to, for example, set the future dates mentioned above or to check the information to make sure that it is complete and consistent. It would be inconsistent, for example, for the diagnosis code to indicate that the insured has ovarian cancer if the insured is a male.

Various periodic payment structures are possible. For instance, an immediate care benefit could be provided upon approval of the claim followed by subsequent payments over the next several years. The subsequent payments could be on anniversaries of the initial payment, or on the policy anniversary dates, the person's birthday, or on other predetermined dates. In addition, intervals of more than or less than one year can be used to trigger the insured's continued survivorship benefit. For instance, survivorship information could be requested, and benefits could be distributed, at six-month intervals or at two-year intervals.

Preferably, but not necessarily, the insurance provider will allocate or otherwise account for funds based on the insured's likelihood of survival in hitting each of the payment milestones within the policy's life. Such considerations can include the probability of surviving the condition, such as the particular type of cancer, the state of progression of the cancer, and the insured's age.

For speed, efficiency and accuracy, and as human judgment is not required for issuance of a policy (that is, the condition is either present or not present), automation by, for example, a computer system is preferred. Although a general purpose computer may provide the starting point, such a general purpose computer must be specifically and particularly adapted, by the provision of input devices, output devices, and programming and/or software modules, to provide the various functions described herein. The adapted computer system can then process input information and automate, for example, the periodic increase in the care benefit amount, the requests for information on the current medical condition of the person and/or that the person is currently alive, the care benefit dates of payment, the verification of a condition for payment (e.g., survival), and/or the disbursement of the payment, such as by a check or an automatic deposit to the insured's checking or savings account. The adapted computer system can also automatically determine which persons have paid the appropriate premiums and other fees to qualify for payment of this benefit. Form letter or form policy generation may further or alternatively be predicated on the condition that another type of policy has been issued to the person or that another type of claim has been paid to the insured. The computer system may confirm that the data provided indicates that an appropriate condition is present in the insured, such as the aforementioned internal cancer. For example, if the attending doctor submits a statement with a medical code indicating a diagnosis with that medical condition, then that medical code may be adequate to initiate the payment and/or survivorship verification actions.

The adapted computer system may: automatically determine whether the person is ineligible for a policy or payments based on a prior event that triggered a previous payment under the policy or payment under another policy, even if that prior event information was obtained subsequent to a policy being issued; generate forms to send to the insured at periodic intervals such that the insured may apply to receive the benefit; generate cover letters to accompany any forms or other documents that it prepares for submission to the insured; and generate a return envelope, including one where postage has been paid or one where postage has not been paid. One such form may be, for example, a statement that the insured was alive on a certain date, such as, for example, a policy anniversary date.

The adapted computer system may also verify that the relevant policy is still active, prior to issuance of a rider to the policy, or the generation of any form. Even if the form is generated, the computer system may perform a subsequent check to verify that the form has not been generated for someone who no longer qualifies. The computer system may further check to ensure that a payment has not already been made to that insured for surviving that specified period. Alternatively or additionally, the computer system may also check to ensure that no form has already been generated on the insured's behalf. The computer system may further check to ensure that the insured's maximum eligibility for the benefit has not expired. For instance, if the benefit is limited to five years, the computer system may check the appropriate database table to ensure that no benefits are distributed beyond that five-year limit. The computer system may also combine any generated forms with other generated forms. For example, the computer system may automatically generate a premium due notice which has, or does not have, a form for verification of survivorship as of a specified date.

The adapted computer system may also perform the tasks listed above in assisting a claims specialist or other individual in assessing whether the relevant rules for payment or policy generation are being properly followed. For example, if the claims specialist erroneously attempts to issue a care benefit for a non-applicable condition, the computer system may respond by initially denying the request and/or prompting the claims specialist for confirmation, and may even bar the claims specialist from proceeding further until the proper information is entered or until an appropriate override or other authorization code is entered. An appropriate override or other authorization code may be necessary, for example, if a condition previously excluded from the policy when originally issued is now covered under more recent, similar policies or a renewal of that policy. Similarly, if the care benefit is $500 annually, the system may prevent two or more payments within a 365-period or other specified period, or payments of more than $1,000, or a limit based upon how long the policy has been in force, within any 365-day period (or other period) so as to prevent payments which deviate from the schedule. The computer system may further limit what a claims specialist can access with regard to the policy. For example, certain persons may be precluded from viewing information regarding the insured when there is no claim pending, or viewing information which is not relevant to a pending claim. The computer system can further bar the printing of a care benefit form for a certain period of time, such as 30 days, following issuance of the insurance policy.

The adapted computer system may also provide the added benefit of automatically rejecting a claim under certain conditions. For instance, a claim could be rejected if the physician's signature date is prior to the first, earliest diagnosis date. Alternatively, the computer system could deny the benefit claim if the physician signature date is within the appropriate year, but the annual care benefit has already been paid for that anniversary year. The computer system may also deny a claim or indicate a policy should be reviewed if, for example, a physician's statement indicates that the specified medical condition was already present at the time the policy was issued or within a predetermined time thereafter. The computer system may reject an internal cancer benefit distribution under an insurance rider if certain initial benefit distributions have not been made by the underlying primary policy. The computer system may also further bar a claim if the insured does not have a requisite medical condition, such as an internal cancer, even if an initial payment or a subsequent payment has already been paid. The computer system may also reject claims based on insufficient information submitted such as, for example, a missing date on an application form, or a missing date on a physician's statement, etc.

The adapted computer system can also work in conjunction with an automated telephone system. For instance, a person could call a telephone number and submit a claim via that telephone call. The telephone system could use a series of prompts wherein the insured could dial digits or say oral commands such that the telephone system could record the insured's claim or provide the information directly to the computer system, preferably for later review by a claims specialist or other appropriate person. This could also be used to initiate printing and mailing of the necessary claim form, or for later payments of the care benefit. Persons can also interact with the system such that they can conveniently renew their policy, determine the status of a claim, and/or take advantage of a customer loyalty discount. A customer loyalty discount may be, for example, a reduction in the renewal premium for a policy, an increase in a benefit payable under a policy, the sending of a refund or rebate check to the person, the option to purchase another policy or a rider without a medical examination or at a reduced premium, etc.

If the insured dies before the date of the next survivorship payment, then in one embodiment the adapted computer system records the death and removes all references, such as calendar dates, to check the insured's future survivorship. This avoids sending reminders which can cause unnecessary grief to the spouse or other relative of the deceased person.

In another embodiment, the adapted computer system will initiate action to verify the insured's status with respect to the periodic points on which the insured would qualify for the care benefit. For example, the computer system will initiate action to verify survivorship, such as by, for example, a combination of electronic verification, human verification by the insurance company, or human verification by mailing a letter and relying on the insured's affirmatively announcing his survivorship.

Some, but not all, embodiments and benefits are set forth herein. Also, many features and benefits are neither mutually inclusive nor mutually exclusive, but may be used individually, or jointly, in any desired combination. Thus, it should be appreciated that it is not necessary to use all the feature and all the benefits of all the various embodiments; one can choose which embodiment(s) and benefit(s) are desirable for a particular situation or to achieve a particular goal and then implement only those.

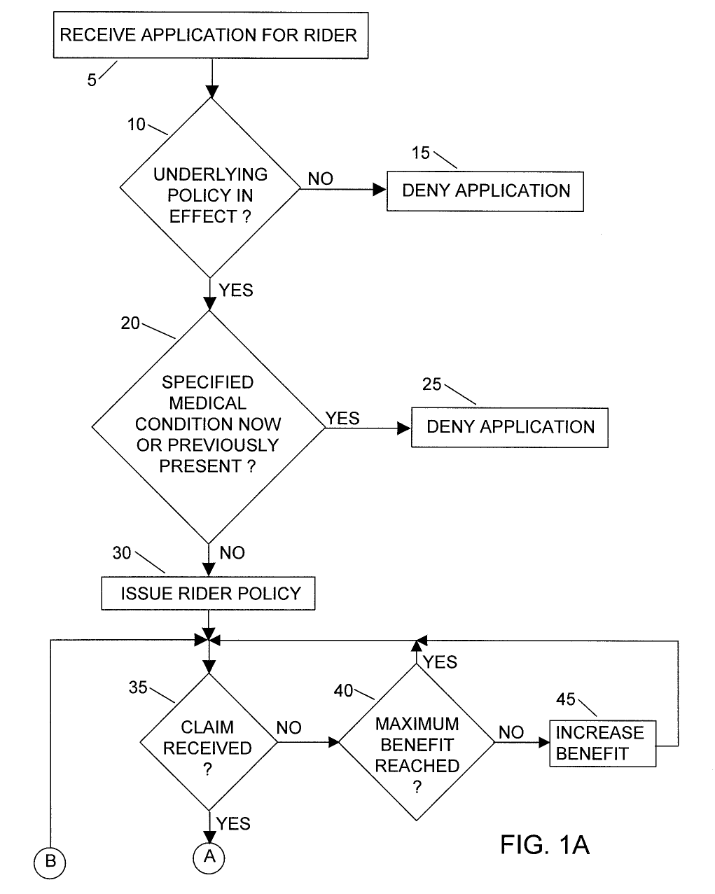

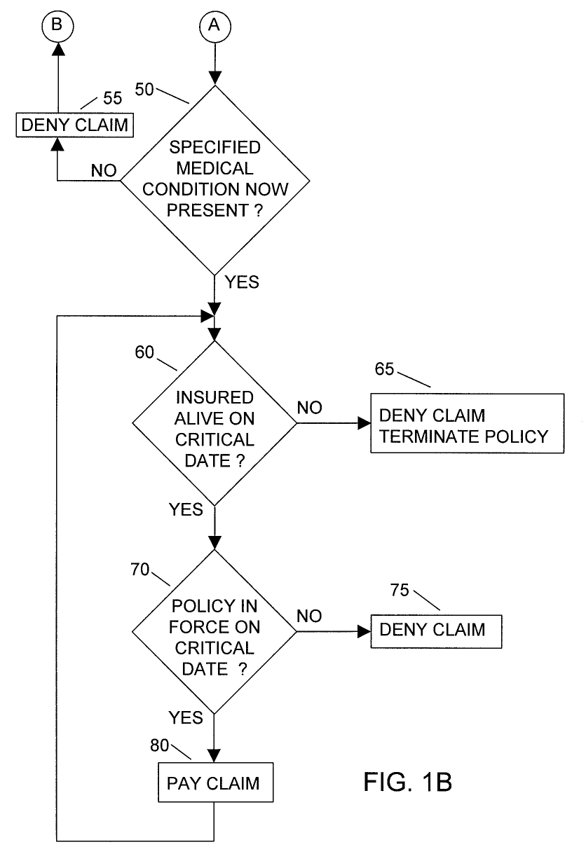

Turn now to FIG. 1, which is a flow chart of an exemplary embodiment. An application for a rider is received 5. Step 10 then tests whether the underlying policy is in effect 10. If the underlying policy is not in effect then the application is denied 15. If the underlying policy is in effect then step 20 tests whether the specified medical condition (or conditions) is now present, or has ever been present (or has been present within some specified previous time period). If so then the application is denied 25. If not then the rider policy is issued 30.

Step 35 tests whether a claim has been received. If not, then step 40 tests, on predetermined dates, such as policy anniversary dates, whether the maximum benefit amount has been reached. If so then a return is made to step 35. If not then the benefit is increased 45 and a return is made to step 35.

If, in step 35, a claim has been received, then step 50 tests whether a specified medical condition is now present. If not then the claim is denied 55 and a return is made to step 35. If the specified medical condition is now present then step 60 tests whether the insured was alive on the critical date. If the insured was not alive at that time then in step 65 the claim is denied and the policy is terminated.

If, in step 60 the insured was alive then step 70 tests whether the policy was in force on the critical date, such as the anniversary date. If not then the claim is denied 75. If so then the claim is paid 80, and then a return is made to step 60 to repeat steps 60 and 70 for the next anniversary date.

Although steps 5 and 10 refer to an underlying policy, that is not a requirement. In an alternative embodiment, an underlying policy is not required, and so step 5 is the receipt of an application for a policy instead of a rider, step 20 is executed next, and steps 10 and 15 are omitted.

Consider now an exemplary situation wherein an individual applies to enroll in an insurance policy or rider that provides a care benefit if he is diagnosed with an internal cancer during the life of the policy. The application is reviewed to see whether the applicant is eligible and considers such factors as whether the insured has previously had one of the covered conditions within, for example, the past five years. If the application is approved, the individual tenders appropriate payment, and after any waiting period has passed then the policy will go into effect. In one embodiment, if cancer occurs within the waiting period then the policy is preferably void and the insured can apply for a refund of the premium. In another embodiment, if cancer occurs within the waiting period then the policy is preferably void and the premium can be automatically refunded. In still another embodiment, if cancer occurs within the waiting period then the policy remains in force but the benefit is not available until the person has survived for two years from the policy date or the date of diagnosis of the cancer, whichever is later.

Assume that, initially, the insured is cancer free so that the policy is issued. Sometime later, after the waiting period is over (for example, 30 days after the policy is issued), the insured is unfortunately diagnosed with the specified medical condition, for example, lung cancer, the diagnosis occurring 270 days after the policy issues. The insured submits a claim to the insurance carrier using, for example, the Internet, mail, telephone, in-person communication, etc. A claims specialist reviews the information and verifies that the relevant data has been properly entered into the system. Once the claims specialist has signed off on the claim, such as by indicating that the data is correct and has been properly entered, and any necessary or desired supervisory review and confirmation has been obtained, the computer system automatically pays the immediate benefits due under the policy. It then calendars the periodic dates in the future to request information whether the insured is still alive and, if the insured is still alive and the policy is still in force, then to pay the benefit.

Assume that, after one year from the date of submitting his original claim, the insured is still alive, that he has been diagnosed with a specified medical condition, that the patent has submitted the diagnosis, and that he has met all of the other conditions set under the policy, such as having made an applicable premium patent, or such as having another valid and active policy with the insurance company. Assume also that the computer system has no record of his death. The computer system may automatically generate a form to be sent to the insured so that he can collect the benefit due to him, or may automatically generate a form whereby the patent can request payment, or a form whereby the insured (or some other appropriate person) can verify that he is still alive. Through some or all of these steps, the insured may be verified as still alive and qualifying under the policy. As the insured has survived the one year anniversary of his claim, the insured is paid a $500 care benefit.

Assume now that, over that following year, the insured's conditions deteriorates, and he dies after his second year anniversary. The computer system will perform the same series of checks to ensure that the insured is a valid beneficiary under the policy and may, for example, generate a form and mail it to the insured's residence. A family member of the deceased person completes the form and mails it back to the insurance company, noting thereon that the insured died on a particular date. The computer system will process the claim and a payment will be made if the insured had been alive on the critical day. If the insured was not still alive on the critical date then the payment will not be made. In another embodiment, if the insured died after the last payment but before the critical date then a final payment may be made anyway.

Upon receipt of the information that the insured has died, a claims specialist will input this information in the computer system, or it will be automatically inputted through other means. On the next anniversary date, the computer system will check the insured's living/deceased status and one identifying the insured's status as deceased not to issue a new care benefit. Alternatively, if the death has been confirmed, then the insured's record may be updated so as to remove any further status inquiries.

Thus assistance is provided for expenses not conventionally compensated by an insurance policy, even without submission of receipts or detailed expense reports. Also, a recurring benefit may be provided for a period of time as long as the insured continues to be alive. The insured receives such a benefit regardless of any specific medical or non-medical costs that insured has incurred in treating, or even not treating, the medical condition, and even regardless of whether another policy may or does cover those costs. This benefit assists the insured with the non-covered costs of visiting the doctor and other inconveniences that arise from living with particular medical conditions, including expenses that are not easily quantifiable.

In one embodiment, the specified medical condition is cancer, and is defined as a disease manifested by the presence of a malignant tumor and characterized by the uncontrolled growth and spread of malignant cells and the invasion of tissue. Cancer also includes, but is not limited to, leukemia, Hodgkin's disease, and melanoma. Also, in one embodiment, the specified medical condition is internal cancer and is defined as any cancer other than nonmelanoma skin cancer. In another embodiment, nonmelanoma skin cancer is defined as a cancer other than a melanoma that begins in the upper part of the skin (epidermis). In another embodiment, associated cancerous conditions are defined as myelodysplastic blood disorder, myeloproliferative blood disorder, or carcinoma in situ (in the natural or normal place, confined to the site of origin without having invaded neighboring tissue) but, other than those mentioned above, preferably, associated cancerous condition does not include other types of premalignant conditions, or conditions with malignant potential.

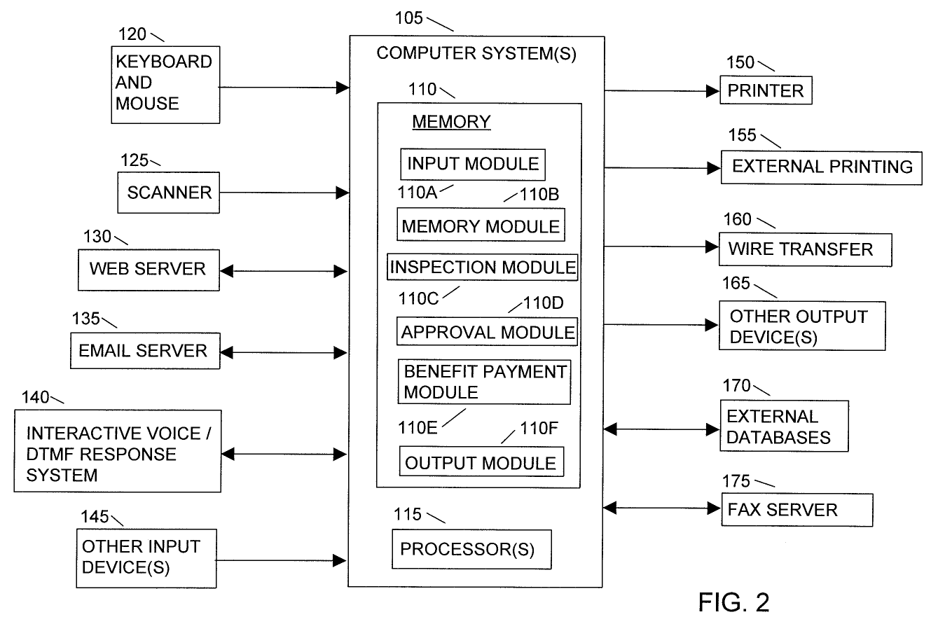

FIG. 2 is a block diagram of an exemplary computer system 105 for use with the present invention. There may be one, or multiple, computer systems 105, depending upon the volume of transactions and how quickly they need to be processed. A computer system 105 has, for example, a memory 110 and one or more processors 115. The memory preferably has volatile memory sections for temporary storage and retrieval of instructions and data, and non-volatile memory sections for storage and retrieval of operating programs, data, forms, etc. Operating instructions are contained in the memory. The operating instructions may be installed into the memory by any convenient means including, for example, downloading from a server, installing from a disk, installing from two or more disks, manual inputting of one or more parameters, or any convenient or desirable combination of one or more of these.

The computer system 105 is preferably connected to a variety of input devices, such as one or more keyboard and mouse devices 120, one or more scanners 125, and one or more other input devices 145. The submitted information is preferably obtained directly and automatically from the devices or documents. For example, if a form or document is completed on-line, then the fields may be directly linked to the information regarding the insured (or proposed insured, as the case may be). If the form or document is received by fax or by email, optical character recognition (OCR) may be used to locate the information (such as by locating a fixed term, such as “name”, or “street address”, etc., and then inspecting the information following that term), and then directly linking that information to the information regarding the insured. Also, different input devices may be used in combination to obtain this information. For example, the OCR software may be in the computer system 105, or may be in a particular input device (or other device), and the device receiving the form or document may be programmed to, or directed by the computer system to, forward the form or document to another device which has OCR software so that the information about the insured may be extracted for further processing. If necessary, although not preferred, human review and manual entry of the information may be performed.

The computer system 105 is preferably connected to a variety of output devices, such as one or more printers 150, one or more external printing operations, such as off-site printing, one or more wire transfer devices 160, and one or more other output devices 165. Automatic payment of a benefit may occur, for example, by causing the appropriate information, such as name, amount, account number, etc., to be sent to a printer which prints an envelope and check, or to a wire transfer system which automatically transfers money from a company account to an account of the insured. The computer system 105 is preferably also connected to a variety of devices which can be input or output devices, depending upon the particular need, such as one or more web servers 130, one or more email servers 135, one or more interactive voice/DTMF response systems 140, one or more external databases 170, and one or more fax servers 175. Either the memory 110 or one or more databases 170 may contain, for example, some or all of the information regarding the policy, the rider, premium and premium payment information, benefit and benefit payment information, medical and other information concerning the insured, forms and form letters, etc. For example, the information could be stored in the database 170, and only brought into the memory 110 when needed; or the information could be stored in the memory 110, with the database 170 being a backup system. The various components shown may be interconnected by any desired technique which provides for the accurate and timely flow of information as desired. Thus, some devices may be connected by a universal serial bus (USB), other devices may be connected by a local area network, such as an Ethernet network, and still other devices may be connected by a fiber network, satellite network, etc. Likewise, the communication protocol used over a particular network is not critical as long as the information may be accurately and timely transferred.

In addition, one computer system 105 may be connected to one or more other computer systems 105 to provide for parallel processing or backup capabilities. The input devices provide for receiving data about a person, the output devices provide for printing forms or documents, mailing forms or documents, paying specified benefits, etc. The processor or processors provide for performing the plurality of functions necessary to perform the steps shown in FIG. 1. The processor(s) preferably employ several modules for performing the plurality of functions.

For example, in one embodiment, the memory 110 preferably contains a plurality of software modules 110A-110F which perform various functions. It will be appreciated that the function performed by a module is not limited by the name of the module. It will also be appreciated that the functions performed by a single module may be performed by two or more modules, that a single module may perform the functions of two or more modules, and that a function may be performed in whole or in part by a module other than the preferred module shown. In one embodiment, the input module 110A may perform step 5 and access one or more of devices 120, 125, 130, 135, 140, 145, 170 and 175. Similarly, in one embodiment, the output module 110F may perform step 80, and access one or more of devices 130, 135, 140, 150, 155, 160, 165, 170 and 175. Also, the memory module 110B may access and/or cause storage and/or retrieval of information in the memory 110, in an external database 170, and/or even in another computer system 105. Similarly, in one embodiment, the benefits payment module 110E may perform step 80 and access one or more of devices 150, 155, 160 and 165. Similarly, in one embodiment, the inspection module 110C may perform one or more of steps 10, 20, 35, 40, 45, 50, 60 and 70. Also, either the inspection module 110C or the input module 110A (or even an input device) may perform the task of directly and automatically obtained the information about the insured from the submitted documents or forms.

Also, in one embodiment, the approval module 110D may perform one or more of steps 20, 35, 50, 60 and 70. Of course, it will be appreciated that the modules may interact with each other to perform a step or part of a step. Also, other input and output devices may become available and/or may be desirable for use in addition to, or instead of, the input and output devices shown herein. Therefore, the present invention is not limited to the specific embodiments shown herein.

Other features and advantages of the present invention will become apparent upon reading the following detailed description of embodiments of the invention.

1. A method for payment of a benefit to a survivor of a medical condition, comprising:
(a) receiving initial information about a person, the information concerning at least one specified medical condition;
(b) automatically inspecting the initial information for the presence of the specified medical condition to determine the state of health of the person, the state of health not being acceptable if the specified medical condition is initially present;
(c) if the state of health of the person is acceptable then approving the person for payment of a specified benefit if the specified medical condition is later present;
(d) receiving subsequent information about the person, the subsequent information concerning whether the predetermined medical condition is later present;
(e) inspecting the subsequent information for the presence of the specified medical condition to determine the state of health of the person, the state of health being changed if the specified medical condition is now present, and
(f) if the state of health of the person has changed then paying the specified benefit.

2. The method of claim 1 wherein the step of receiving initial information comprises receiving information as to whether the person has cancer as a medical condition.

3. The method of claim 1 wherein the step of receiving information comprises receiving initial information as to whether the person had cancer as a medical condition within a predetermined time period.

4. The method of claim 1 wherein the specified benefit is paid on a specified date.

5. The method of claim 1 and, after receiving the subsequent information and before paying the specified benefit, further comprising:
(a) receiving survivorship information concerning whether the person is alive on a specified date, and
(b) if the person is still alive on the specified date, then paying the specified benefit.

6. The method of claim 1 and, after receiving the subsequent information and before paying the specified benefit, further comprising:
(a) sending a request for verification that the person is still alive;
(b) receiving survivorship information, the survivorship information concerning whether the person is alive on a specified date, and
(c) if the person is still alive on the specified date, then paying the specified benefit.

7. The method of claim 1 wherein the specified benefit is a predetermined amount.

8. The method of claim 1 wherein the specified benefit is paid annually.

9. An article of manufacture comprising: a machine accessible medium containing data that, when accessed by a machine, causes the machine: to receive and store initial information and subsequent information about a person, the initial information concerning at least one predetermined medical condition, the subsequent information concerning whether the predetermined medical condition is later present; to inspect the initial information to determine the initial state of health of the person, the initial state of health not being acceptable if the predetermined medical condition is present; if the state of health is acceptable then to approve the person for payment of a specified benefit if the medical condition is later present; to inspect the subsequent information to determine the state of health of the person, the state of health being changed if the predetermined medical condition is later present; and, if the state of health has changed then to pay the specified benefit.

10. The article of manufacture of claim 9 wherein the data further causes the machine to receive and store initial information as to whether the person initially has cancer as a medical condition.

11. The article of manufacture of claim 9 wherein the data further causes the machine to receive and store initial information as to whether the person had cancer as a medical condition within a predetermined time period.

12. The article of manufacture of claim 9 wherein the data further causes the machine to pay the specified benefit on a specified date.

13. The article of manufacture of claim 9 wherein the data further causes the machine, after receiving the subsequent information and before paying the specified benefit, to:
(a) receive and store subsequent information concerning whether the person is alive on a specified date, and
(b) pay the specified benefit if the person is still alive on the specified date.

14. The article of manufacture of claim 9 wherein the data further causes the machine, after receiving the subsequent information and before paying the specified benefit, to:
(a) send a request for verification that the person is still alive;
(b) receive and store subsequent information concerning whether the person is alive on a specified date, and
(c) pay the specified benefit if the person is still alive on the specified date.

15. The article of manufacture of claim 9 wherein the data further causes the machine to pay the specified benefit as a predetermined amount.

16. The article of manufacture of claim 9 wherein the data further causes the machine to pay the specified benefit annually.

17. A system, comprising:
(a) an input module for receiving initial information and subsequent information about a person;
(b) a memory module to receive, store, and retrieve the initial information and the subsequent information received by the input module;
(c) an inspection module to automatically inspect the initial information to determine whether a predetermined medical condition is initially present, and to inspect the subsequent information to determine whether the predetermined medical condition is later present;
(d) an approval module to, if the predetermined medical condition is not initially present, approve the person for payment of a specified benefit if the medical condition is later present and cause a document to be generated concerning approval of the person for the specified benefit;
(e) a benefit payment module to, if the specified medical condition is later present, cause the specified benefit to be paid; and
(f) an output module, responsive to the benefit payment module, to cause at least one of: printing of the document, or payment of the specified benefit.

18. The system of claim 17 wherein the benefit payment module causes the specified benefit to be paid on a specified date.

19. The system of claim 17 wherein the inspection module, if the predetermined medical condition is later present, causes a document to be generated requesting verification that the person is still alive.

20. The system of claim 17 wherein:
(a) the inspection module, if the predetermined medical condition is later present, causes a document to be generated requesting verification that the person is still alive and inspects further information to determine whether the person is still alive; and
(b) the benefit payment module causes the specified benefit to be paid if the specified medical condition is present and the person is still alive.

21. The system of claim 17 wherein the benefit payment module causes a predetermined amount to be paid as the specified amount.

22. The system of claim 17 wherein the benefit payment module causes the predetermined amount to be paid annually.

23. The method of claim 1 wherein at least one of the steps of receiving information or inspecting information comprises automatically obtaining the initial information and the subsequent information from at least one of a submitted document or a submitted form.

24. The article of manufacture of claim 9 wherein the data that, when accessed by a machine, causes the machine automatically obtain the initial information and the subsequent information from at least one of a submitted document or a submitted form.

25. The system of claim 17 wherein at least one of the input module or the inspection module comprises logic for automatically obtaining the initial information and the subsequent information from at least one of a submitted document or a submitted form.
